(19) United States
(12) Patent Application Publication
(10) Pub. No.: US 2026/0138152 A1
(43) Pub. Date: May 21, 2026

(54) METHOD FOR WAXING A CAR BODY

(71) Applicant: AUDI AG, lngolstadt (DE)

(72) Inventors: Dirk BÄDER, Fellbach (DE); Andreas EHM, Großmehring (DE)

(73) Assignee: AUDI AG, lngolstadt (DE)

(21) Appl. No.: 19/351,498

(22) Filed: Oct. 7, 2025

(30) Foreign Application Priority Data
Nov. 19, 2024 (DE) 102024133785.0

(51) Int. Cl. B05C 11/08; B05C 1/02; G01K 1/14

(52) U.S. Cl. CPC B05C 11/08; B05C 1/02; G01K 1/14

(57) ABSTRACT

A method for waxing a car body with a wax, where a wax pad is attached to the car body. The wax pad is opened mechanically or thermally at a defined process point in order to release the wax and apply it to the car body. Existing thermal energy of the body and/or the wax pad from one of the preceding manufacturing steps, such as coating and/or drying, is used to liquefy the wax without the need to supply additional thermal energy in order to liquefy the wax. An optimization of a wax flow then takes place by tilting, rotating, and/or vibrating the car body in order to ensure even distribution of the wax in cavities of the car body.

### FIELD

The technical field of the invention is a method for corrosion protection treatment of car bodies using wax.

### BACKGROUND

The state of the art comprises common methods for waxing vehicle bodies, which mainly use spray waxing systems or flood waxing systems. In a spray waxing system, the wax is sprayed onto the body, while in a flood waxing system the body is completely flooded with wax. These processes require a significant amount of energy, since both the wax and the car body must be brought to a high temperature to liquefy the wax. This leads to high energy consumption because the wax must be continuously kept at temperature.

In addition, there are design challenges because inlet and outlet holes must be provided in the body for the flood waxing system, which leads to structural weakening and additional costs. Other disadvantages of these conventional methods are excess wax and contamination, since often too much wax is applied, which results in both a waste of resources and the risk of carryover and wax deposits in the car body.

DE2755947A1 discloses a method for applying a layer of a corrosion-inhibiting material to hard-to-reach surface areas of a metallic object, in particular a motor vehicle body. The method uses both heat and optionally solvents to liquefy the corrosion-inhibiting material and apply it efficiently to the relevant surface areas.

DE4328716A1 discloses a motor vehicle having at least one component susceptible to corrosion, with which a corrosion-inhibiting agent in the form of a volatile corrosion inhibitor is associated. The component is a part of the vehicle structure that is particularly susceptible to corrosion due to its material properties or its exposure to environmental influences.

WO2021026207A1 discloses a coating composition for applying a hydrophobic film to a target surface which contains a quaternary ammonium silane, a polyalkylene glycol, and an optional solid lubricant. In addition, a kit is provided containing an applicator with the above composition and instructions for applying the composition to a wiper blade of a vehicle in order to apply the hydrophobic film to the vehicle windshield contacted by the wiper blade.

### SUMMARY

It is the object of the present invention to provide a method for applying wax to a car body which improves energy efficiency and at the same time ensures a uniform distribution of the wax, particularly in cavities that are hard to reach.

The invention relates to a method for waxing a car body in which a wax pad containing wax is attached to the car body and is opened mechanically or thermally at a defined process point in order to release the wax and apply it to the car body. Existing thermal energy from previous manufacturing steps, such as painting or drying, is used to liquefy the wax without the need for additional thermal energy. The wax flow is then optimized by tilting, rotating, or vibrating the car body to ensure even distribution of the wax in the cavities of the car body.

The term wax pad refers to a solid element filled with wax that is attached to the car body and whose shell is opened during a defined process step to release the wax. The heat energy comes from previous drying or painting processes of the car body and is used to liquefy the wax in the wax pad. The wax flow optimization process comprises mechanical manipulation of the car body, such as tilting, rotating, or vibrating, to ensure that the wax is evenly distributed into all intended areas, particularly hard-to-reach cavities.

A key advantage of this process is saving thermal energy, since no additional energy is required to liquefy the wax. The use of existing thermal energy leads to a more efficient waxing process and reduces operating costs. Even distribution of the wax in the cavities also improves the corrosion protection of the car body.

Advantageously, the wax pad can have an adhesive layer that enables full-surface adhesion to the car body.

The adhesive layer refers to a layer that is applied to the wax pad and ensures a secure connection to the car body. The preferred adhesive for the adhesive layer is butyl, which is particularly suitable due to its adhesive properties and temperature resistance.

This ensures that the wax pad remains firmly attached to the car body throughout the entire processing time without slipping or falling off, allowing for precise placement and optimal wax distribution.

Advantageously, the wax pad can be fastened by clamping or inserting as an alternative or in addition to the adhesive method.

The term clamping refers to the mechanical fixation of the wax pad by means of clamping devices, while inserting describes the placement of the pad in designated recesses or depressions in the car body.

This provides a flexible fastening method that can be varied depending on the body type and application without compromising the structural integrity of the vehicle.

Advantageously, a plurality of wax pads are provided which can be attached to places on the car body that allow the wax to accumulate in certain cavities without the wax running off further.

The term accumulation refers to the targeted positioning of the wax in areas where it can concentrate and form a protective layer.

This ensures efficient use of the wax by keeping it in critical areas and preventing it from flowing off uncontrollably, thus increasing the protection against corrosion.

Advantageously, wicks or similar sensors can be integrated into the car body to check wax distribution.

Wicks or similar sensors describe devices that are able to detect the distribution or presence of wax inside the car body and provide feedback on the correct amount and/or position of wax.

This enables precise monitoring of wax distribution, improving quality assurance of the waxing process and ensuring that corrosion protection is guaranteed in all relevant areas.

Advantageously, the wax pads can be opened by mechanical action, such as piercing with a mandrel using compressed air.

The term mechanical action describes a physical force applied to the wax pad to open its shell and release the wax, such as by using a mandrel.

The function of the mandrel in the described method is to mechanically open the wax pad to release the wax contained therein. The mandrel is used by mechanical action (e.g. compressed air) to specifically pierce or perforate the shell of the wax pad. This enables a controlled and precise release of the wax at a defined process point without the need for additional thermal energy or other external influences. The mandrel thus ensures an efficient and reproducible activation process of the wax pad.

This ensures a controlled opening of the wax pad, allowing precise release of the wax at a precisely defined time without unwanted distribution or loss.

Advantageously, after opening the wax pad, the car body can be subjected to further heat treatment to ensure that the wax takes up its final position and hardens.

Heat treatment is a process in which the car body is reheated to optimize the flow of the wax and distribute it evenly before it hardens.

This stabilizes the positioning of the wax, resulting in improved adhesion and protection, especially in hard-to-reach areas of the body.

Advantageously, the wax pads can be subjected to a quality test before being applied to the car body to ensure that they have the required mechanical and thermal properties for the respective process step.

The term quality testing describes the checking of the wax pad for specific properties such as temperature resistance, adhesion, and mechanical stability.

This ensures that only wax pads that meet the requirements of the respective manufacturing process are used, which increases the reliability and efficiency of the method.

Advantageously, the wax pad can be equipped with an integrated temperature sensor that detects the temperature of the wax inside the pad to determine the optimal time for releasing the wax.

The term temperature sensor refers to a device that is capable of measuring the temperature inside the wax pad and sending signals to control the opening mechanism.

This ensures that the wax is only released under optimal conditions, ensuring even distribution and effective protection.

Advantageously, a plurality of wax pads can be attached to predefined attachment points on the car body to ensure optimal wax distribution in hard-to-reach cavities and corners.

The term predefined attachment points describes specially marked or prepared locations on the car body that are intended for the placement of the wax pads.

This ensures maximum efficiency in wax distribution, especially in areas that are particularly susceptible to corrosion, increasing the longevity of the car body.

Another subject matter of the invention relates to a device for carrying out the method for waxing a car body described above, which device is designed to ensure efficient and uniform application of wax to cavities of the car body that are hard to reach.

The device comprises at least one wax pad containing wax for application to the car body. The wax pad is attached to the car body and is provided with an adhesive layer that allows full adhesion to the car body part, ensuring safe and stable positioning throughout the entire treatment. The adhesive layer is preferably made of a material such as butyl, which provides both strong adhesion and tolerates the thermal effects during wax application.

A central component of the device is the opening device, which is designed for mechanical or thermal activation of the wax pad at a defined process point. This opening device allows targeted release of wax from the wax pad onto the car body. The device uses the thermal energy of the car body and/or the wax pad, which was introduced into the component through previous manufacturing steps, such as painting or drying, to liquefy the wax. This efficient use of existing thermal energy reduces the need for additional energy supply and thus contributes to energy savings and an improved process flow.

To ensure an even distribution of the wax in the cavities of the car body, the device is equipped with a control unit. This control unit allows the optimization of the wax flow by tilting, rotating, and/or vibrating the car body. These mechanisms ensure that the wax is evenly distributed into hard-to-reach cavities, thus achieving a continuous coating and thus optimal corrosion protection.

The advantages of this device are the targeted and economical use of thermal energy as well as the efficient and even distribution of wax on and in the car body, which enables a sustainable and comprehensive treatment of the car body areas that are at risk of corrosion.

### BRIEF DESCRIPTION OF THE FIGURES

The invention is schematically illustrated in the drawings based on embodiments. In the figures:

FIG. 1 shows a flow chart of an embodiment of the method according to the invention for the treatment of car body components.

### DETAILED DESCRIPTION

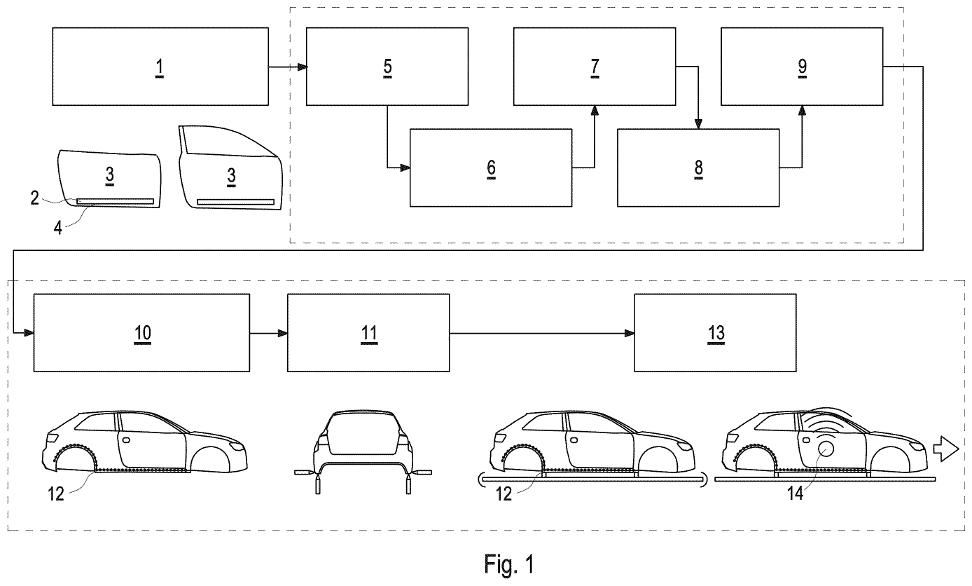

FIG. 1 shows a flow chart of an embodiment of the method according to the invention for the treatment of car body components. The process flow is divided into two areas: a conventional process flow and a new process flow using the wax pad.

In a first step 1 according to the invention, a wax pad 2 is applied to a car body part 3, which part is processed either in the body shop or optionally at the supplier's. The wax pad 2 can be attached to individual components, such as a door 3 or a side panel. An adhesive layer 4, preferably made of butyl, is used to ensure full-surface and stable adhesion to the car body.

The next step 5 comprises the already known pass through cathodic dip coating (CDC) in which the wax pad 2 is protected in order to keep the wax in the solid state. In the next step 6, the car body part is dried at temperatures of 140- 185° C. in the downstream dryer for cathodic dip coating, whereby the wax in the wax pad is liquefied for the first time but still remains in a shell that is part of the wax pad.

This is followed by the application of polyvinyl chloride (PVC) in the next already known step 7, in which additional protective layers such as seals and damping mats are applied before the component is passed through another dryer for the PVC layers at temperatures of 100-120° C. in the next step 8. In this step as well, the wax in the wax pad remains in the shell and liquefies for the second time.

In the last, already known step 9 of the conventional process, the car body part is dried in the dryer for the top coat at about 150° C., wherein the wax in the wax pad is liquefied once again, but is still held back by the shell.

In the new step 10, the wax remains liquid within the wax pad 2 in a discharge zone of the top coat dryer. In the next step 11 according to the invention, activation of the wax pad 2 begins in that the shell is opened mechanically or thermally in order to release the wax, such that the wax flows into certain areas 12 of the car body which are to be protected, in particular from corrosion. The wax pad or the shell enclosing it and containing the wax can be opened by piercing it with a mandrel and/or using compressed air. The thermal energy stored in the body during the previous process steps, such as drying, is used to liquefy the wax without the need for supplying additional energy.

In the final step 13, the wax flow in the cavity is optimized. In this step, mechanical influences such as tilting, rotation or vibration 14 of the car body, as indicated in the illustration, ensure even distribution of the wax in order to ensure a complete coating of all relevant surfaces.

### LIST OF REFERENCE NUMERALS:

1—application of the wax pad
2—wax pad
3—car body part (e.g. door or side panel)
4—adhesive layer
5—pass through cathodic dip coating (CDC)
6—drying for cathodic dip coating
7—application of polyvinyl chloride (PVC)
8—drying for the PVC layers
9—drying for the top coat
10—outlet zone of the topcoat dryer
11—activating the wax pad
12—certain areas of the car body (protection against corrosion)
13—optimization of the wax flow in the cavity
14—mechanical influences (tilting, rotation, vibration)

1. A method for waxing a car body with a wax, wherein a wax pad is attached to the car body, which wax pad contains wax and is opened mechanically or thermally at a defined process point in order to release the wax and apply it to the car body, wherein existing thermal energy of the body and/or the wax pad from one of the preceding manufacturing steps, such as coating and/or drying, is used to liquefy the wax without the need to supply additional thermal energy in order to liquefy the wax, wherein an optimization of a wax flow then takes place by tilting, rotating, and/or vibrating the car body in order to ensure even distribution of the wax in cavities of the car body.

2. The method of claim 1, wherein the wax pad has an adhesive layer, preferably made of butyl, which enables full-surface adhesion to the car body.

3. The method of claim 1, wherein the wax pad is fastened to the car body by clamping using clamping means and/or by inserting it into recesses provided for this purpose.

4. The method of claim 1, wherein a plurality of wax pads are provided and are attached to locations on the car body which allow the wax to accumulate downwards in cavities provided for this purpose without the wax running off further.

5. The method of claim 1, wherein, in order to control the distribution of the wax, wicks or similar sensors for detecting the distribution of the wax in the body are attached, which sensors enable a check of the even distribution of the wax.

6. The method of claim 1, wherein the wax pad is opened by a mechanical action, such as piercing with a mandrel, and/or using compressed air.

7. The method of claim 1, wherein the car body is subjected to a further temperature treatment after the wax pad has been opened in order to ensure that the wax takes up its final position on the car body and hardens.

8. The method of claim 1, wherein the wax pad is subjected to a quality check before being attached to the car body in order to ensure that the wax pad has the required mechanical and thermal properties for the respective process step.

9. The method of claim 1, wherein the wax pad has at least one integrated temperature sensor which detects the temperature of the wax within the wax pad, wherein an optimal time for the activation of the wax pad and the release of the wax is determined based on the determined temperature.

10. An apparatus for carrying out the method of claim 1, comprising:
at least one wax pad containing wax for application to a car body, wherein the wax pad is attached to the car body and has an adhesive layer which enables full-surface adhesion;
an opening device for mechanically or thermally activating the wax pad at a defined process point in order to release the wax, wherein the thermal energy of the body and/or the wax pad from previous manufacturing steps, such as coating and/or drying, is used to liquefy the wax;
a control unit for optimizing the wax flow by tilting, rotation, and/or vibrations of the car body in order to ensure an even distribution of the wax in the cavities of the body.

11. The method of claim 2, wherein the wax pad is fastened to the car body by clamping using clamping means and/or by inserting it into recesses provided for this purpose.

12. The method of claim 2, wherein a plurality of wax pads are provided and are attached to locations on the car body which allow the wax to accumulate downwards in cavities provided for this purpose without the wax running off further.

13. The method of claim 3, wherein a plurality of wax pads are provided and are attached to locations on the car body which allow the wax to accumulate downwards in cavities provided for this purpose without the wax running off further.

14. The method of claim 2, wherein, in order to control the distribution of the wax, wicks or similar sensors for detecting the distribution of the wax in the body are attached, which sensors enable a check of the even distribution of the wax.

15. The method of claim 3, wherein, in order to control the distribution of the wax, wicks or similar sensors for detecting the distribution of the wax in the body are attached, which sensors enable a check of the even distribution of the wax.

16. The method of claim 4, wherein, in order to control the distribution of the wax, wicks or similar sensors for detecting the distribution of the wax in the body are attached, which sensors enable a check of the even distribution of the wax.

17. The method of claim 2, wherein the wax pad is opened by a mechanical action, such as piercing with a mandrel, and/or using compressed air.

18. The method of claim 3, wherein the wax pad is opened by a mechanical action, such as piercing with a mandrel, and/or using compressed air.

19. The method of claim 4, wherein the wax pad is opened by a mechanical action, such as piercing with a mandrel, and/or using compressed air.

20. The method of claim 5, wherein the wax pad is opened by a mechanical action, such as piercing with a mandrel, and/or using compressed air.
